(19) United States
(12) Patent Application Publication
(10) Pub. No.: US 2007/0005756 A1
(43) Pub. Date: Jan. 4, 2007

(54) Shared data center monitor

(76) Inventors: Robert Comparato, Sparta, NJ (US); Frank Grande, Oakland, NJ (US); Olli Jason, Milford, PA (US); Mario Caramico, Wantagh, NY (US); Warren Tan, South River, NJ (US)

Correspondence Address: BAKER & BOTTS, 30 ROCKEFELLER PLAZA, 44TH FLOOR, NEW YORK, NY, 10112-4498, US

(21) Appl. No.: 11/337,161

(22) Filed: Jan. 19, 2006

Related U.S. Application Data
(60) Provisional application No. 60/645,260, filed on Jan. 19, 2005.

(51) Int. Cl. G06F 15/173

(52) U.S. Cl. 709/224

(57) ABSTRACT

Systems and methods for monitoring and reporting data center activity are provided. The data center includes mainframe computers and client servers linked to user devices over networks. Start tasks, batch jobs and online regions on the mainframe computers are monitored and reported to a server. The reported data is parsed and formatted for display at user devices via a client interface.

### CROSS REFERENCE TO RELATED APPLICATION

The present application claims the benefit of U.S. Provisional Patent Application No. 60/645,260 filed Jan. 19, 2006, which application is incorporated by reference in its entirety herein.

### FIELD OF THE INVENTION

The present invention relates to computer data centers. The invention in particular relates to systems and methods for data center management.

### BACKGROUND OF THE INVENTION

Modern computer data centers can be large and complex. The complexity of data centers is often in proportion to the business services, data processing needs, or number of customers serviced by the data centers. Examples of large and complex data centers are those run by the Securities Industry Automation Corporation (SIAC®). SIAC runs the data centers including computer systems and communications networks that power the American stock exchanges and disseminate U.S. market data worldwide.

The SIAC data centers have complex hardware and software environments (using, for example, IBM mainframe computers as host computers). Multiple Logically Partitioned Systems (LPAR) are used to service customers across multiple data centers that interface with host computers running different operating systems. Each computer system (and, in many cases, each software application) has its own status monitoring tools. These tools, which may be valuable in their own right to diagnose and fix problems that arise in the operation of the particular system or software application, are generally beyond the level of knowledge of the operations personnel manning the data centers. Using current technology, monitoring several computer systems and software applications in one data center or across several data centers is difficult and labor intensive. Thus current technology hinders maintenance of the data centers for proper or optimal operational conditions.

Consideration is now being given to improving data center management. In particular, attention is being directed to systems and methods for monitoring data center status and activity.

### SUMMARY OF THE INVENTION

Systems and methods are provided for improved data center management. The inventive systems and methods combine individual system and application monitoring tool results in an integrated presentation, on which basis data center support and maintenance activities can be directed or implemented efficiently. The inventive systems and methods utilize a standard tool (e.g., Shared Data Center Monitor (“SDCMON”)) to integrate and present information on data center status and activity to one or more users. The information may be presented over conventional communication links (e.g., internet, intranet, or other computer and telecommunication networks or links) to one or more users.

The SDCMON components are distributed over one or more computer systems and communication networks. SDCMON may be implemented as a series of programs that combine the advantages of low-level mainframe programming with Graphical User Interface (GUI) object oriented programming to produce an easy to use and effective system management tool. SDCMON can be configured to provide audio and visual alerts pertaining to the status of system processing on an exception basis for operations and technical staff via a standard client interface. Using TCP/IP socket programming, information is sent from IBM mainframe and Client Server platforms such as UNIX or NT to a server program, which parses the data and sends it (also via TCP/IP) to a server. At this server, the information is formatted and via a client interface can be viewed on multiple levels by an unlimited number of individuals from the technical areas down to the customer level. At the client level, a drill down facility allows for query on the tasks being monitored. Information available from the drill down includes: user contact information, jobs affected by this task, schedule information, vendor information and restart information. A database facility for historic archives of information that includes types of problems, frequency of problems, and time required to fix problems may also be used.

The SDCMON may be configured to standardize alerts and messages across diverse hardware platforms and operating systems. The standardization of alerts and messages can beneficially reduce the learning curve for operations staff and minimize the margin of error. The SDCMON may further be advantageously configured to use a minimum of system resources An exemplary test implementation of SDCMON, which is fairly representative of a large-scale mainframe environment, uses less than 1 minute of CPU and approximately 20 thousand I/O's per day. In practice, the resource demand or utilization will vary depending on the number of monitored tasks.

### BRIEF DESCRIPTION OF THE DRAWING

Further features of the invention, its nature, and various advantages will be more apparent from the following detailed description of the preferred embodiments and the accompanying drawing, wherein like reference characters represent like elements throughout, and in which:

FIG. 1 is a schematic illustration of a system and method for monitoring data center components in accordance with the principles of the present invention.

### DESCRIPTION OF THE INVENTION

Systems and methods are provided for improved data center management. The inventive systems and methods integrate and present information on data center status and activity (e.g., system task availability, job abends, scheduling, and online region activity) to operations staff and management personnel. The systems and methods may be advantageously utilized to improve the performance of data center(s) which are technologically and/or geographically diverse.

The inventive systems and methods may utilize a standard tool (e.g., Shared Data Center Monitor (“SDCMON”)) to integrate and present information on data center status and activity to one or more users. The information may be presented over conventional communication links (e.g., internet, intranet, or other computer and telecommunication networks or links) to one or more users.

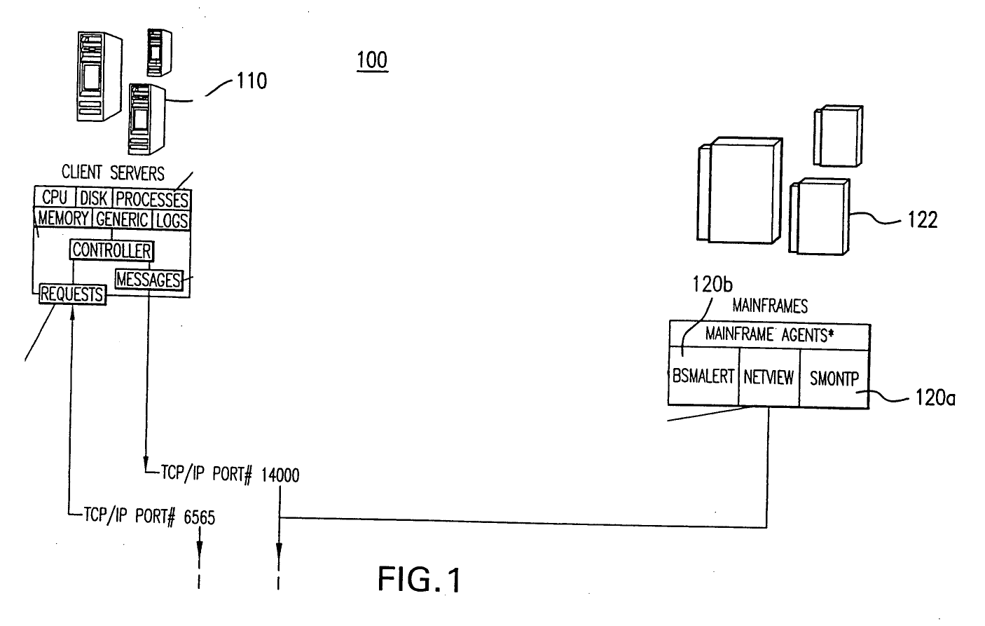

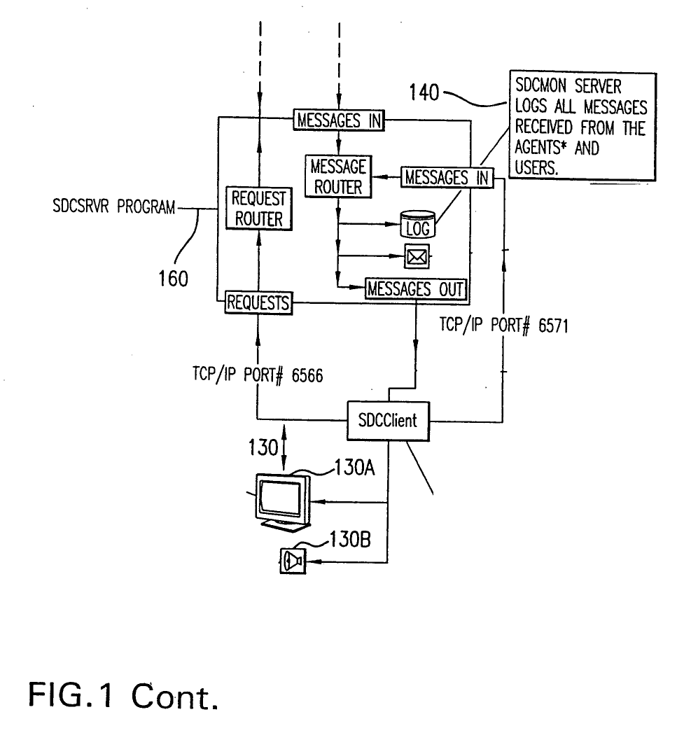

FIG. 1 shows an exemplary SDCMON (e.g., tool 100) whose components are distributed over or linked to one or more computer systems and communication networks (e.g., client servers 110, main frames 120, user computer 130 and a server 140). Tool 100 may be implemented as a series of programs that combine the advantages of low-level mainframe programming with Graphical User Interface (GUI) object oriented programming to produce an easy to use and effective system management tool. Tool 100 may be configured to provide audio and visual alerts (e.g., via computer display 130a and/or speaker 130b) pertaining to the status of system processing on an exception basis for operations and technical staff via a standard client interface.

In the operation of tool 100, information is sent from mainframe 120 and Client Server 110 platforms such as UNIX or NT using TCP/IP socket programming to a server program 160. Server program 160 parses the received information and sends the parsed data (e.g., via TCP/IP) to a server (e.g., server 140). At the server, the parsed information or data is formatted for viewing via a client interface. The data may be formatted so that it can be viewed by any number of clients or users from multiple levels, for example, the technical levels down to the customer levels.

At the client level, tool 100 may include a drill down facility which allows for query on the tasks being monitored. Information available from the drill down may include: user contact information, jobs affected by this task, schedule information, vendor information and restart information. A database facility or historic archive of information that includes types of problems, frequency of problems, and time required to fix problems may also be used in conjunction with tool 100.

With reference to FIG. 1, each mainframe LPAR which is connected to tool 100 may include a mainframe agent (e.g., tool 100 component SMONTP 120a) to collect data on Started Tasks or batch jobs running on it. In exemplary implementations, component SMONTP 120a may be written in assembler language or other low level language that is very close to machine language. This closeness to machine level language has the advantage of using very little CPU and I/O resources. It also allows for access to the lowest levels of the operating system known as its control blocks. From these control blocks information may be gathered and problem determination can start. Component SMONTP 120a is configured so that it also communicates with other batch jobs that are running to gather information on production jobs that have or have not run. Component SMONTP 120a may further be configured to provide visual and/or audio alerts to the operation staff for scheduling problems and on batch programs that have terminated abnormally.

In addition, tool 100 may be configured to monitor online regions which may be on strict time schedules. Batch jobs are conveniently run before such regions are activated and immediately upon their termination. Component SMONTP 120a may be configured so that it collects this data and passes any alerts to the operator about regions coming down too early or not being brought up on time.

Mainframes 120 that are monitored by SMONTP 120a may, for example, have an IBM z/OS Operating System (also known as MVS). MVS consists of a myriad of programs running in concert to provide the services necessary to run the most robust and error-free operating system possible. MVS includes a number of products from third party vendors that provide additional functionality to the MVS operating system. These tasks provide for running an efficient and error-free environment. When the SMONTP 120a task starts on an individual LPAR, it loads into storage a table of tasks that should be active on that LPAR (e.g., started tasks). The table of tasks may include the start and end time for each task. SMONTP 120a may be configured to scan through the internal control blocks of the system to determine if a task is active or inactive. By scanning external tables, which may be set up by the user, it may be possible to limit alerts to those times that tasks should actually be active.

In an exemplary implementation of tool 100, the scanning interval is set at 30 seconds, but can be changed via an operator command as desired by the user or customer. By including a check of the system clock against the time the task should be up and the time it should be taken down, tool 100 generates a task status message (e.g., stating that a task is not active when it should be and conversely, that it is active when it should not be). The information for each task in the table of tasks is then sent by tool 100 via the TCP/IP protocol to another tool 100 component (e.g., server program 160 “SDCSRVR”). Server program 160 may be run on a separate or different LPAR. Further, tool 100 may be configured so that SMONTP 120a is configured so that the only I/O by or at SMONTP for task processing is the initial load of the table of tasks into storage and any IP data sent to the server. This IO configuration limitation can be significant because it has minimal impact on system resources.

Tool 100 may include another component (e.g., tool 100 component BSMALERT 120b) for collecting or monitoring data on batch jobs. Conventional scheduling packages (e.g. IBM's OPC and Computer Associates' CA7) allow for the complex scheduling of batch jobs based on job, time, or other requirements being met. Jobs depend on other jobs to be finished or completed before they can run. BSMALERT 120b may be configured as a separate batch job (BSMALERT) itself that runs on a production system and reads the logs that the scheduling package is constantly updating. BSMALERT 120b may be configured so that a unique record is written into the log for each job start and job end. The BSMALERT job reads these logs and compares them to a table of jobs and the times by which the jobs should be completed. BSMALERT 120b may be configured so that if a job has not completed by its specified time, a record is sent to an external data set where it may be read by SMONTP 120a. SMONTP 120a may then forward the record or information to server program 160 (SDCSRVR). The forwarded record or information may be marked with a suitable identifier which distinguishes it from started task data. Tool 100 may in response issue suitable alerts or notifications (e.g., an audio alert, highlight forwarded record or information in red). Appropriate operations personnel may also be paged to investigate the alert.

Tool 100 may be configured for monitoring online regions, upon which many critical security industry functions are dependent. In the securities industry, online regions allow for the interactive entry of data from brokers and trading floor systems. It is important that online regions be active, without any interruption. When the online regions terminate normally, in most cases, they trigger complex batch job streams that process data entered into the systems from the beginning of the day. If any of these online regions come down prematurely, it is important that data center operations staff or personnel recognize the interruption and promptly notify the appropriate personnel for corrective action. For monitoring online regions, SMONTP 120a may be configured to act or treat the online regions in the same manner as started tasks. SMONTP 120a may be configured so that when online regions end (either normally or abnormally) the end times are compared against a table of times for the regions. In instances where an online region has come down abnormally or prematurely, SMONTP 120a/tool 100 may be configured to send a visual and audio alert.

Tool 100 may be configured so that server program 160 (SDCSRVR) is a central collection point for the data being sent from all the frames running SMONTP 120a. Server program 160 (SDCSRVR) may be configured to run on the mainframe or server as a started task. Server program 160 (SDCSRVR) as shown in FIG. 1 acts as a data processing traffic cop intercepting and forwarding data. Server program 160 uses standard TCP/IP sockets to receive the data directly from the frames. Server program 160 may be configured to gather data/information, validate its content and parse it with header information. It then sends the data to the server on the network where tool 100 server program is running.

In exemplary implementations, server program 160 (SDCSRVR) may be written in the REXX language, a high level language, which is very convenient for socket interface because it is very portable. Since server program 160 (SDCSRVR) is designed so that it does not use any system information (i.e., MVS control blocks), using a high level language does not cause any appreciable system degradation. In an exemplary implementation of tool 100, server program 160 (SDCSRVR) uses approximrately 3 minutes of CPU and performs about 200 thousand I/O per day. With minimal changes to the code (mostly in the I/O area) the exemplary server program 160 (SDCSRVR) may be adapted to run on various platforms such as UNIX, LINIX, or NT.

Tool 100 may be configured so that its server and Graphical User Interface (GUI) portions can run on any number of servers (e.g., on a local area network). In an exemplary implementation, there may be two servers that are designated to act as Production and Backup servers, respectively. They consist of (1) a listener, which waits to hear from the SDCSRVR task that is running on the mainframe, and (2) the client software that displays the formatted data. The data is sent via TCP/IP services.

In the exemplary implementation, the GUI portion of tool 100 is a JAVA program that formats the data from the server based on a header field sent by the SMONTP program. The GUI is designed with different buttons and columns for data based on type (e.g., started tasks, online regions, or scheduled batch jobs) within the production frame. Additionally, the GUI may be designed to allow a user to drill down on any task listed and gather information to aid in debugging or scheduling conflicts. The GUI may be simultaneously active on multiple clients or users whose number may be limited only by server size. Since the standard TCP/IP protocol is used there are no known network constraints. Any user with access to the LAN (e.g., via a SIAC 800 number) can access tool 100 remotely.

It will be noted that tool 100 and its components SMONTP 120a, BSMALERT 120b, SDCSRVR 160, SDCMON GUI 130, etc. are designed for convenience in installation and maintenance. In the exemplary implementation, component SMONTP 120a runs as a started task or as a batch job on an MVS mainframe system. It needs no special attributes or security access. It reads MVS control blocks that require no special privileges and are accessible by any problem program. The structure of these control blocks is not likely to be change in future releases of MVS, thus minimizing maintenance of tool 100. Further, the batch job scheduling data is a standard feed from an external program (BSMALERT) that can be adapted to any scheduling package. This feed is done from a batch job that constantly reads the logs being updated from the scheduling package. Maintenance would be necessary whenever any changes to the log file of the scheduling package occurred. Tables would need to be set up by the users to define tasks and batch jobs to be monitored. The SDCSRVR program is a REXX program that runs as a started task or batch job on the mainframe. It uses the standard TCP/IP protocol to receive data from SMONTP and sends it along to the LAN server. System modifications may be made to add or remove feeds into the program from multiple MVS systems or frames. The SDCMON GUI is written in the JAVA programming language. It will run on any PC platform (Windows 98, Windows 2000, or NT), Unix platform (Solaris, Linux, AIX), or any platform that supports the Java Virtual Machine (JVM). It runs on a standard LAN server. In order to run the GUI on a client the JAVA runtime feature must be installed. This is free software, downloadable from the Internet. Java code is downward compatible; that is, new versions of JAVA will be compatible without recompiling the programs. The SDCMON interfaces with the server program, which acts as the collection point of the data.

In accordance with the present invention, software (i.e., instructions) for implementing the aforementioned monitoring systems and methods can be provided on computer-readable media. It will be appreciated that each of the steps (described above in accordance with this invention), and any combination of these steps, can be implemented by computer program instructions. These computer program instructions can be loaded onto a computer or other programmable apparatus to produce a machine such that the instructions, which execute on the computer or other programmable apparatus, create means for implementing the functions of the aforementioned demand forecasting systems and methods. These computer program instructions can also be stored in a computer-readable memory that can direct a computer or other programmable apparatus to function in a particular manner such that the instructions stored in the computer-readable memory produce an article of manufacture including instruction means, which implement the functions of the aforementioned monitoring systems and methods. The computer program instructions can also be loaded onto a computer or other programmable apparatus to cause a series of operational steps to be performed on the computer or other programmable apparatus to produce a computer implemented process such that the instructions which execute on the computer or other programmable apparatus provide steps for implementing the functions of the aforementioned monitoring systems and methods. It will also be understood that the computer-readable media on which instructions for implementing the aforementioned monitoring systems and methods are be to provided include, without limitation, firmware, microcontrollers, microprocessors, integrated circuits, ASICS, and other available media.

It will be understood, further, that the foregoing is only illustrative of the principles of the invention, and that those skilled in the art can make various modifications without departing from the scope and spirit of the invention, which is limited only by the claims that follow. For example, conventional monitoring software tools such Netview (sold by IBM) may be integrated with tool 100. See FIG. 1. Further, the text boxes in FIG. 1 describe additional features of exemplary implementations of tool 100. For brevity, that description is not repeated in this section of the specification.

1. A method for monitoring and reporting data center activity, wherein the data center includes mainframe computers and client servers linked to user devices over networks, the method comprising;
monitoring at least one of start tasks, batch jobs and online regions on a mainframe and reporting the monitored data to a server;
parsing the reported data;
formatting the parsed data so that it can be viewed via a client interface at a user device.

2. The method of claim 1, further comprising providing a graphical user interface at the user device for displaying the formatting data.

3. The method of claim 1, wherein formatting the parsed data comprises generating standardized alerts and messages across diverse hardware and operating systems.

4. The method of claim 1, wherein formatting the parsed data comprises gathering the data, validating its content and parsing it with header information.

5. The method of claim 4, wherein gathering the data comprises receiving data the over TCP/IP sockets.

6. The method of claim 4, wherein gathering the data comprises receiving data independent of mainframe system information.

7. The method of claim 4, wherein formatting the parsed data comprises using a program written in high level language.

8. A system for monitoring and reporting data center activity, wherein the data center includes mainframe computers and client servers linked to user devices over networks, the system comprising a processing arrangement configured to:
monitor at least one of start tasks, batch jobs and online regions on a mainframe and report the monitored data to a server;
parse the reported data;
format the parsed data so that it can be viewed via a client interface at a user device.

9. The system of claim 8, wherein the processing arrangement further comprises a graphical user interface at the user device for displaying the formatting data.

10. The system of claim 8, wherein the processing arrangement is configured to format the parsed data so as to generate standardized alerts and messages across diverse hardware and operating systems.

11. The system of claim 8, wherein the processing arrangement is configured to format the parsed data by gathering the data, validating its content and parsing it with header information.

12. The system of claim 11, wherein the processing arrangement is configured to gather the data over TCP/IP sockets.

13. The method of claim 11, wherein the processing arrangement is configured to gather the data independent of mainframe system information.

14. The method of claim 8, wherein formatting the parsed data comprises using a program written in high level language.

15. A computer-readable medium for monitoring and reporting data center activity, wherein the data center includes mainframe computers and client servers linked to user devices over networks, the computer-readable medium having a set of instructions operable to direct a processing system to perform the steps of:
monitoring at least one of start tasks, batch jobs and online regions on a mainframe and reporting the monitored data to a server;
parsing the reported data;
formatting the parsed data so that it can be viewed via a client interface at a user device.

16. The computer-readable medium of claim 15 comprising instructions operable to direct the processing system to provide a graphical user interface at the user device for displaying the formatting data.

17. The computer-readable medium of claim 15 comprising instructions operable to direct the processing system to gather the data, validate its content and parse it with header information.

18. The computer-readable medium of claim 17 comprising instructions operable to direct the processing system to gather the data over TCP/IP sockets.

19. The computer-readable medium of claim 17 comprising instructions operable to direct the processing system to gather the data independent of mainframe system information.

20. The computer-readable medium of claim 17 comprising high-level language instructions operable to direct the processing system to format the parsed data.
